(19) United States
(12) Patent Application Publication
(10) Pub. No.: US 2025/0177871 A1
(43) Pub. Date: Jun. 5, 2025

(54) SYSTEMS AND METHODS FOR DYNAMIC CHAT TRANSLATION

(71) Applicant: Sony Interactive Entertainment INC., Tokyo (JP)

(72) Inventors: Glenn Black, San Francisco, CA (US); Murugan Rajenthiran, Bangalore Urban (IN); Sharath Rao, San Francisco, CA (US); Jin Zhang, San Mateo, CA (US)

(73) Assignee: Sony Interactive Entertainment INC., Tokyo (JP)

(21) Appl. No.: 18/527,191

(22) Filed: Dec. 1, 2023

(51) Int. Cl. A63F 13/87; G02B 27/00; G06F 40/42

(52) U.S. Cl. CPC A63F 13/87; G02B 27/0093; G06F 40/42

(57) ABSTRACT

System, process, and device configurations are provided for dynamic chat translation and interactive game control. Methods can include receiving communications for a user of an electronic game and converting communications using a localization setting and a machine learning model for language processing to replace one or more segments of the communication. Updated communications may be output with replacement segments to provide automatic conversion of information in a user's understanding. By automatically adapting outputting voice or text of a game chat and/or game output, such as non-player character (NPC) chat, users may have improved understanding. In addition, systems and methods include detecting user reactions, including use of eye tracking data, to assess communication conversion and to update processes and models for conversion of communications.

### FIELD

The present disclosure is directed to systems and methods for dynamic chat translation and interactive entertainment control, including machine model language translation, electronic game control, game content rendering, gaming device operations, and gaming device processes.

### BACKGROUND

Computer and console games titles have been developed in many styles for different gaming systems and platforms. As device processing increases and game play environments become more immersive, there is a desire for enhancement of content and customization of content to a user. There also exists a desire to leverage entertainment functionality to improve communication between users. Many titles and applications of games include users in varying locations including and for gaming sessions with players in one or more regions of a country and international locations. There exists a desire to facilitate player communication and to improve communication, such as in-game chat and in-game communication features. For existing systems that include menu settings or pre-programmed settings, preprogrammed arrangements may not be suitable for all users. As such, there is also a desire for configurations that allow for increased functionality based on user needs. There also exists a desire to accommodate users in different locations and with different communication styles.

### BRIEF SUMMARY OF THE EMBODIMENTS

Disclosed and described herein are systems, methods and device configurations for dynamic chat translation and interactive game control. In one embodiment, a method includes receiving, by a device, a communication for a first user of an electronic game, the device storing a localization setting for the first user, and converting, by the device, the communication using the localization setting and a machine learning model for language processing, wherein converting includes replacing at least one segment of the communication with a replacement segment. The method also includes outputting, by the device, an updated communication including the replacement segment to the user.

In one embodiment, the communication is at least one of a voice communication and a text communication provided by an interface of the electronic game.

In one embodiment, the communication is at least one of audio output and text output of a character of an electronic game.

In one embodiment, converting the communication includes replacing at least one of voice, audio and text of the communication with a translated communication as the replacement segment.

In one embodiment, the localization setting includes at least one of a regional, location and language preference of the user.

In one embodiment, the machine learning model is configured based on a training set of data for the user and a localization dataset.

In one embodiment, converting the communication includes replacing the at least one segment including offensive commentary.

In one embodiment, the method includes detecting a reaction of the user to the replacement segment and updating the machine learning model based on the reaction.

In one embodiment, the method includes detecting a reaction includes detecting, by the device, eye tracking data for the user, and wherein the eye tracking data is detected during the output of the replacement segment.

In one embodiment, the method includes updating the machine learning model for language processing using the reaction of the user to the replacement segment.

Another embodiment is directed to a device configured for dynamic chat translation. The device includes an interface configured to output gaming content, a memory storing executable instructions and a controller, coupled to the interface and memory. The controller is configured to receive a communication for a first user of an electronic game, the device storing a localization setting for the first user, and convert the communication using the localization setting and a machine learning model for language processing, wherein converting includes replacing at least one segment of the communication with a replacement segment. The controller is also configured to output an updated communication including the replacement segment to the user.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of dynamic chat translation and eye tracking according to one or more embodiments;

FIG. 2 illustrates a process for dynamic chat translation according to one or more embodiments;

FIG. 3 illustrates a graphical representation of a device configuration according to one or more embodiments;

FIG. 4 illustrates a graphical representation of dynamic chat translation training according to one or more embodiments; and

FIGS. 5A-5B are graphical representations of dynamic chat translation and interactive game control according to one or more embodiments.

### DETAILED DESCRIPTION OF THE EXEMPLARY EMBODIMENTS

### Overview and Terminology

One aspect of the disclosure is directed to dynamic translation of communications for electronic devices and electronic games, including gaming consoles, network games and network based applications for interactive and entertainment devices. detecting and using eye tracking data for control and presentation of gaming content. Dynamic chat translation may include conversion of communications or portions of communications, such as communication segments, such that presentation of the communication is translated. Translation of the communications may be performed by processes and operations such that output of the communication may be provided in a seamless and/or near seamless configuration for users. Embodiments are directed to gaming systems which may include consoles, processors or servers that generate game media and interactive entertainment devices configured to provide output and receive user input. Translation of communications can be applied to applications associated with gaming systems, including in game chats and communication streams. Embodiments may also be applied to one or more game functions, such as character dialogue and outputs.

Processes and device configurations are provided for dynamic chat translation and interactive game control. Communication may be received for a first user of an electronic game, including one or more of voice, text and audio data. Using a localization setting for a user and a machine learning model for language processing, at least one segment of the communication may be replacement or converted into a replacement segment. The communication may be output with the replacement segment to the user. According to embodiments, cultural models of language may be used to allow for automatic conversion of information for one or more of words, terms, phrases, sayings and even communications according to a cultural understating. By way of example, if another player uses different measurement units or local slang, these segments in a communication may be adapted such that a receiving player hears a converted version of the communication (e.g., feet to meters, “trashcan” to “rubbish bin”, etc.). In addition, poorly or incorrectly translated game texted or language may be automatically detected by comparing localized behavior against a model developed to represent expected user behavior. Dynamic translation may be configured to convert segments of communications based on local or regional language styles. In addition, dynamic translation may be configured to detect and convert offensive language. By way of example, gaming content and/or communications for an older audience may be converted to remove offensive language, such as profanity. Dynamic chat translation may also be used to convert output of game characters, such as non-player characters. In a multiplayer environment, game element output, such as character output, may be controlled to be modified for players part of a gaming session. For example, a first player may receive a game communication from a game character and a second player may receive the game communication including one or more converted segments.

According to embodiments, dynamic chat translation may be performed using a machine learning model for language processing. Embodiments include one or more operations and device configurations for using and updating machine learning models. Processes may use machine learning models including communication databases for audio, graphical, text and language models to detect and convert communications. According to embodiments, machine learning models may be configured to operate based on one or more localization settings. Localization settings may include one or more of a regional (e.g., country, state, city, town, geographical area in general) and cultural parameter (e.g., age demographic, language, dialect, etc.). In addition to localization settings, processes and device configurations are provided to include one or more models for cultural understanding, including training parameters for appropriate behavior, game play reactions, acceptable communication and offensive communication.

According to embodiments, a machine learning model for language processing and dynamic chat translation may be updated and/or trained based on user reactions. Embodiments may detect user reactions to converted communications, including one or more of facial expressions, and body movements. According to embodiments, operations may include detecting eye tracking data to detect discrepancies and/or incorrect conversion of communications. Poorly or incorrectly translated game text and language may be detected by comparing player behavior, such as a player response, against am model developed to represent expected user behavior. An expected user behavior model may be built using a large body of player data. When discrepancies are noticed specific to one or more localizations, a notification may be generated that an improved human translation is needed by the developer.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

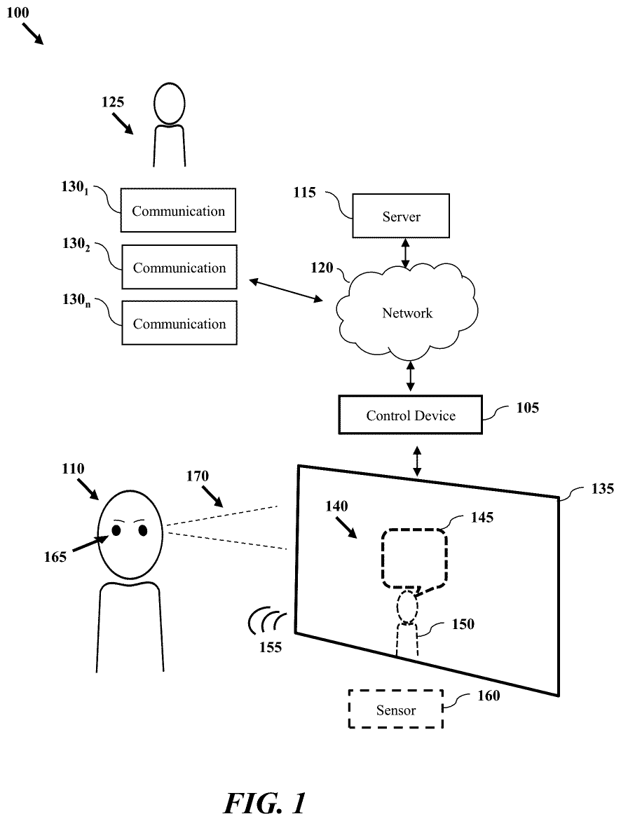

FIG. 1 is a graphical representation of dynamic chat translation and eye tracking according to one or more embodiments. According to embodiments, one or more devices of system 100 may be configured for dynamic chat translation. System 100 includes control device 105 which may be configured to receive communications, convert one or more segments of the communications and output to user 110. According to embodiments, one or more operations may be performed by a network device, such as server 115, which may be configured to convert one or more segments of the communications and output to user 110 by way of network 120 and one or more devices, such as control device 105.

According to embodiments, communications for user 110 may be automatically converted to information associated with a user's understanding. Conversion of communications may be performed based on one or more localization settings for a user. According to embodiments, conversion of communications by system 100 may be performed using a machine learning model. One or more devices of System 100, such as control device 105, server 115 and display device may perform operations of a machine learning model. According to embodiments, conversion of communications may be performed for a user, such as user 110, by one or more devices of system 100, including control device 105 and/or server 115. It should be appreciated that multiple users of a device may be provided converted communications by one or more of control device 105 and server 115. System 100 may perform one or more processes described herein.

According to embodiments, communications may be provided to a user for one or more communication channels of an electronic game and interactive media in general. According to embodiments, control device 105 relates to a game controller, such as a game console. It should be appreciated that that one or more of serer 115 and display device 135 may be configured to provide electronic game functions, game control and interactive media output. It should also be appreciated that dynamic chat conversion is not limited to electronic games. The principles of the disclosure may be provided to other forms of network and interactive communication. For purposes of illustration and example of operation may include user 110 receiving communications from another user, user 125. User 110 and user 125 may each be participating in an electronic game and/or communication channel (e.g., game chat, game messaging, game communication feature, etc.) allowing for exchange of one or more of text, image data, audio data, and voice data. According to embodiments, one or more elements of system 100 may convert one or more segments of communications for user 110. It should also be appreciated that operations may be configured to receive communications from user 110 and convert communication segments for output to one or more other users, such as user 125.

According to embodiments, user 125 may generate one or more communications for user 100 and/or to a game chat/game communication feature. FIG. 1 illustrates a plurality of communications 1301-n generated by user 125 which may be communicated by way of network 120 to at least one of control device 105 and server 110. According to embodiments, control device 105 and server 115 may operate independently or jointly to convert communication segments.

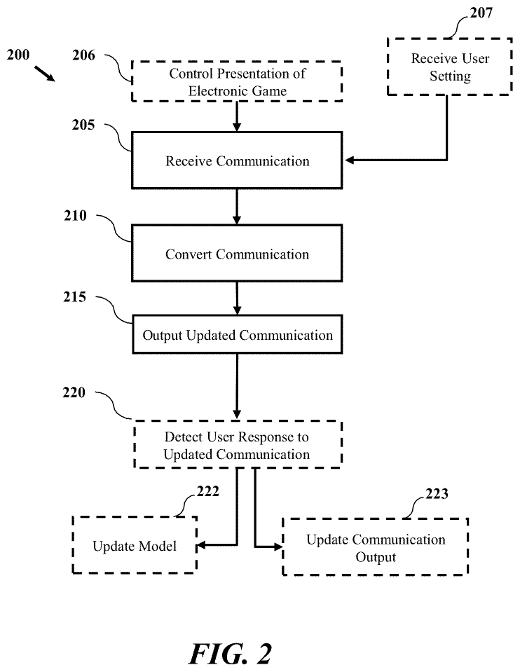

According to embodiments, dynamic chat conversion may include converting at least one communication, such as at least one of communications 130₁₋ₙ, for output. Alternatively, one or more game communications may be converted, such as text or audio of a non-player character (NPC). Processes are provided for each type of communication. One or more devices may perform operations of process 200 descried with reference to FIG. 2. According to embodiments, operations may be performed for an electronic game, or media in general, output by display 135. When communications 130₁₋ₙ relate to user speech, such as voice of user 125, conversion of the communication may be output as audio by control device 105. Similarly, control device may provide audio output to display device 135 for output. When communications are text, such as part of a game chat or game element communication, such as NPC text or audio, conversion may be display by display device 135 and/or output as audio. Display device may output display content 140 based on data received from one or more of control device 105 and server 115. Converted communications may be displayed graphically as communication 145. Game content may be displayed to include a graphical element, such as NPC 150. Communications may be output as audio 155.

According to embodiments, conversion of segments of communications may be performed using a machine learning language model. Processes for conversion are discussed with reference to FIGS. 2 and 4. According to embodiments, system 100 may be configured to use and update machine learning models. One or more devices of system 100 may monitor user reactions to converted communication segments. FIG. 1 detection of one or more reactions 165 of user 110 including eye tracking data 170.

System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

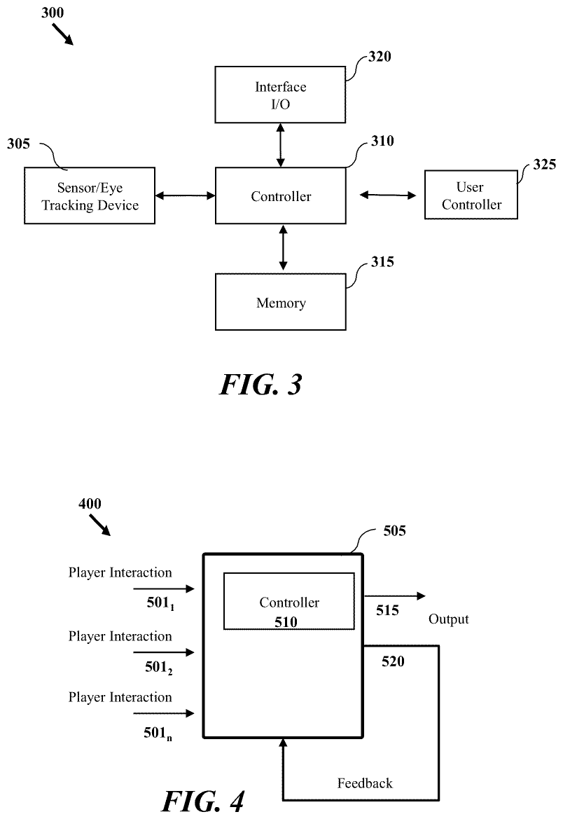

FIG. 2 illustrates a process for dynamic chat translation according to one or more embodiments. Process 200 may convert one or more segments of communications for dynamic chat translation. Process 200 may be performed by a device, such as device 300 and/or controller 310 of FIG. 3, for at least one of dynamic chat translation, updating models for processing of communication. Process 200 may be initiated by a device (e.g., control device 105, server 115, device 305, etc.) receiving communications at block 205. According to embodiments, communications may be received for a user in connection with one or more communication functions of an electronic game, such as a game chat. According to embodiments, communications for a user may be based on one or more game elements, such as NPC communications for output to a user. Processes and configurations described herein allow for using machine learning models to convert one or more segments communications. In addition, processes and configurations allow for detecting user reaction to conversions include detection of eye tracking data to identify user gaze, and user reaction in general. Receiving a communication at block 205 may include receiving a communication for a first user of an electronic game. The communication may be received by a device storing a localization setting for the first user. Received communications may include at least one of a voice communication and a text communication provided by an interface of the electronic game. In the context of a game chat, communications may be received as part of a game chat stream. According to embodiments, received communications include at least one of an audio output and text output of a character of an electronic game. Communications may be one or more of text and audio output to a user in connection with an electronic game.

Process 200 may also optionally include receiving a user setting at optional block 207. The user setting may include a localization preference for a user. In some instances, a user selects a localization setting. Alternatively or in combination, the localization setting may be determined for a user based on one or more of a user's physical location, user profile, data detected for a user, language settings, etc. According to embodiments, process 200 may control output of gaming content may be based on a localization setting. A user setting received at optional block 207 may include a user profile providing user preferences of gaming device output and gaming output, language preferences, audio preferences etc.

At block 210, process 200 includes converting received communications. According to embodiments, converting a communication includes using the localization setting and a machine learning model for language processing. Converting can replacing at least one segment of the communication with a replacement segment. By way of example, if a received communication uses different measurement units or local slang compared to a localization setting, these segments in a communication may be adapted such that a receiving player hears a converted version of the communication (e.g., feet to meters, “trashcan” to “rubbish bin”, etc.). Converting the communication can include replacing at least one of voice, audio and text of the communication with a translated communication as the replacement segment. The localization setting can includes at least one of a regional, location and language preference of the user. According to embodiments, the machine learning model is configured based on a training set of data for the user and localization dataset. Localization may be trained based on terminology, phrases or sayings for users in a geographic area and/or based on one or more profile settings. In addition to preferences, one or more unwanted communications may be modified. For example, converting the communication can include replacing segments including at least one of profanity and offensive commentary.

According to embodiments, machine learning models may use one or more cultural models based on location, locality, and language. Cultural models may include parameters to impart nuance of communications styles for one or more localization settings, including but not limited to cultural appropriateness, and morality settings. In addition to direct communications the model may be applied to comment feeds in electronic games. Some game and interactive entertainment user interfaces do not allow for feedback or use a limited display function to correct model. Accordingly, embodiments provide operations and features to support different gaming platforms and user interfaces. Embodiments may be deployed to game functions to detect communication (language, text, voice) within the game system.

At block 210, process 200 includes outputting an updated communication including the replacement segment to the user. The updated communication can be automatically output to be presented in real-time or near real time to convert one or more segments of a communication. Output of the updated communication may be in the form of at least one of voice, audio and text of the communication. According to embodiments, output may include outputting control information to an electronic game to control game elements, such as output of language for a NPC.

According to embodiments, process 200 may optionally include detecting a user response to updated communications at block 220. Machine learning models may be used to generate content and feedback may be difficult to obtain. Block 220 may include detecting a reaction of the user to the replacement segment and updating the machine learning model based on the reaction. Detecting a reaction can include detecting eye tracking data for the user, such as eye tracking data detected during the output of the replacement segment. According to embodiments, eye tracking data may be detected or received from one or more peripheral devices or devices integrated with the gaming device. Eye tracking data can include at least one of a focus point, eye movement, eye movement speed, eye movement frequency, blink rate, pupil dilation and eye opening size. Eye tracking data can include parameters related to a user's eyes, and can also include parameters related to time focusing on gaming content, time looking away from gaming content, and even characteristics such as intensity of a user's gaze. For example, one or more of pupil size, eye direction and eyelid opening size may be used to infer an intent gaze or non-interested gaze. According to embodiments, a gaming device can receive eye tracking inferences and/or monitor the eye tracking data for a player to make determinations about the effect that the game is having on the player. Detecting eye tracking data at block 220 can include determining lack of focus by monitoring player eye movements. Eye movement data, such as speed, frequency, and size of eye movements, can be used in determining the state of the player. Related data from eye tracking, such as blink rate, pupil dilation, and how wide open the player's eyes are can also be determined. Detecting eye tracking data at block 220 can include determining level of stress, boredom, tiredness of the player, and/or user's level of interest in the game play. Process 200 may include using eye tracking data to correlate a player's current state with presented communications.

According to embodiments, detecting eye tracking data at block 220 can include processing image data of a user, such as video data of a user's eyes, to assess one or more of user state and eye characteristics. By way of example, raw eye tracking data may be processed to determine where a user is looking and other parameters, such as the amount of pupil dilation, eye movement speed, and eye opening level. The processed eye data may be correlated with media that is being presented to determine user engagement and/or interaction with the media. Displayed objects a user is paying attention to may be identified. An example of engagement data can include if a user's eyes open wider when a particular action is shown in the media. The engagement and interaction data may be used to determine updates to make to the media presentation. Engagement and interaction data can also be used to effect game play when game media is played.

At optional block 222, process 200 can include updating the machine learning model for language processing using the reaction of the user to the replacement segment. When a conversion is incorrect or receives a user reaction that is unfavorable, such as a confused look, eye-roll, etc., process 200 may update the communication output at optional block 223.

Process 200 may include controlling presentation of an electronic game at block 220 and optional block 223. For example, gaming content may be received from data, game media (e.g., disk, etc.) another device or over a network connection. Communications from an NPC character to a player may be modified based on the user reaction to communication of the game that have been updated including modifying and/or controlling presentation of content, such as gaming content, gaming video and audio output.

FIG. 3 illustrates a graphical representation of a device configuration according to one or more embodiments. Device 300 provides a configuration for a device configured for dynamic chat translation (e.g., control device 105) and may relate to a gaming console, media device, and/or handheld device. Device 300 may be configured to present and update communications and gaming content using one or more localization settings. According to embodiments, device 300 includes sensor/eye tracking device 305, controller 310, and memory 315. Device 300 may also include an interface (e.g., network communication module, input/output (I/O) interface) 320. Device 300 may receive input from a user controller (e.g., game controller) 325. Device 300 may output gaming content to a display using interface 320.

Controller 310 may relate to a processor or control device configured to execute one or more operations (e.g., executable instructions) stored in memory 315, such as processes for dynamic chat translation. Memory 315 may be non-transitory memory configured to provide data storage and working memory operations for device 300. Memory 315 may be configured to store computer readable instructions for execution by controller 310 for one or more processes described herein. Interface 320 may be a communications module configured to receive and transmit network communication data.

Device 300 may be configured to receive gaming media (e.g., card, cartridge, disk, etc.) and output visual and audio content of the gaming media to a display. For network games, device 300 may receive game data from a network source. Device 300 may be configured to receive input from one or more peripheral devices, such as sensor 305 and user controller 325.

Controller 300 may be configured to control presentation of communications, convert communications and present gaming content. Controller 300 may also detect user reactions to converted communications, including detecting eye tracking data for at least one user. Controller 300 may also be configured to convert communications using the localization setting and a machine learning model for language processing. Controller 300 may also be configured to output an updated communication including a replacement segment to the user

FIG. 4 illustrates a graphical representation of dynamic chat translation training according to one or more embodiments. According to embodiments, conversion of communication segments may be determined using one or more references and models. Information for a user, including user habits, reactions, sayings, terminology and local communication style may be determined based on a training process. In addition, a profile may be determined for each user including one or more localization settings that apply to a user. FIG. 4 illustrates training process 400 which can include receiving player interactions 401₁₋ₙ as training input by a device 405 including a controller 410. According to embodiments, controller 410 may receive a plurality of communications including text, audio, voice and user sounds. In embodiments, player interactions 401₁₋ₙ may include eye tracking data detected during presentation of gaming content and converted communications. Based on the training in process 400, controller 410 may generate output 415. Output 415 may include one or more communication segments and replacement segments. According to embodiments, controller 410 may be configured to generate output 415 based on a recursive loop including training and feedback. Feedback loop 420 may provide information such as ratings and accuracy for output 415.

According to embodiments, training process 400 and controller 410 may be configured to use one or more machine learning models (e.g., artificial intelligence, iterative models, etc.) to identify communications and communication style. Training process 400 and controller 410 may use one or more libraries of common user responses. According to embodiments, output 415 may include output of communications with at least one modified segment.

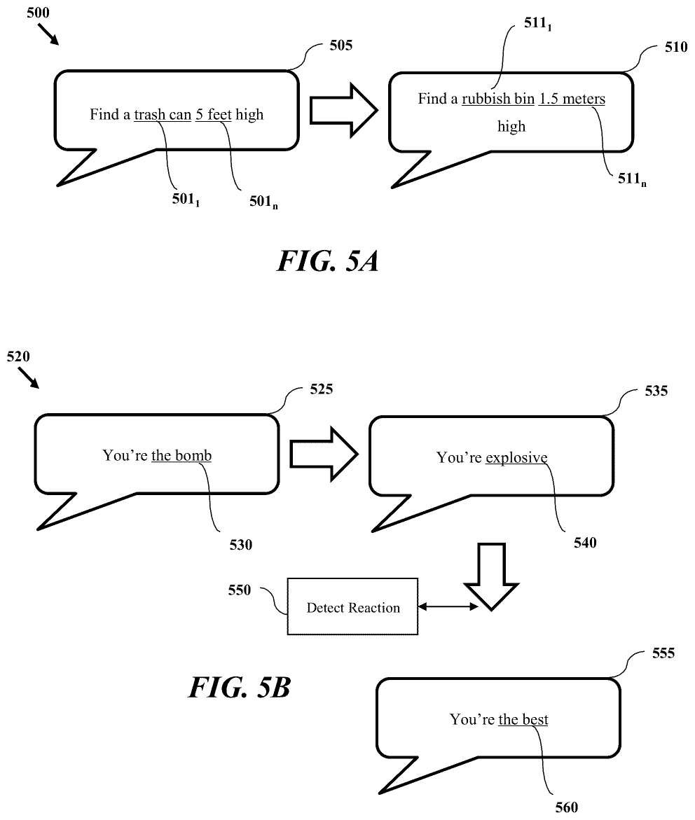

FIGS. 5A-5B are graphical representations of dynamic chat translation and interactive game control according to one or more embodiments. Converting can include replacing at least one segment of the communication with a replacement segment. By way of example, if a received communication uses different measurement units or local slang compared to a localization setting, these segments in a communication may be adapted such that a receiving player hears a converted version of the communication (e.g., feet to meters, “trashcan” to “rubbish bin”, etc.).

FIG. 5A illustrates process 500 including communication 505. According to embodiments, process 500 can include converting communication 505 to replace at least one segment of the communication with a replacement segment. Communication 505 includes communication segments 501₁₋ₙ including one or more elements that can be modified. According to embodiments, communication segments 501₁₋ₙ may be detected using a machine learning model for language processing and at least one localization setting. Communication segment 501₁ refers to a trash can and communication segment 501ₙ refers to a value unit of measurement (e.g., 5 feet). According to embodiments, an exemplary conversion of communication 505 may include conversion to communication 510 by converting communication segments 501₁₋ₙ to communication segments 511₁₋ₙ. Communication segment 511₁ refers to a rubbish bin instead of a trash can and communication segment 511ₙ refers to a value unit of measurement (e.g., 1.5 meters).

FIG. 5B illustrates process 520 including communication 525. According to embodiments, process 520 can include converting communication 5525 to replace at least one segment of the communication with a replacement segment. Communication 525 includes communication segment 530 including the term “bomb” as a slang reference to mean something or someone that is very good. According to embodiments, communication segment 530 may be detected using a machine learning model for language processing and at least one localization setting. According to embodiments, one or more conversions may be updated when conversions are not accurate. An exemplary conversion of communication 525 may include conversion to communication 535 by converting communication segments 530 to communication segment 540. Communication segment 540 replaces the term “bomb” with the term “explosive.” Process 520 may include detecting a reaction of a user at block 550. In the event of a poor translation process 520 may include generating an updated communication 555 with communication segment 560. Communication segment 560 replaces the term “explosive” with the phrase “the best”. It should be appreciated that the examples in processes 500 and 520 are exemplary, and that other terms and phrases may be employed.

While this disclosure has been particularly shown and described with references to exemplary embodiments thereof, it will be understood by those skilled in the art that various changes in form and details may be made therein without departing from the scope of the claimed embodiments.

What is claimed is:

1. A method for dynamic chat translation, the method comprising:
receiving, by a device, a communication for a first user of an electronic game, the device storing a localization setting for the first user;
converting, by the device, the communication using the localization setting and a machine learning model for language processing, wherein converting includes replacing at least one segment of the communication with a replacement segment; and
outputting, by the device, an updated communication including the replacement segment to the user.

2. The method of claim 1, wherein the communication is at least one of a voice communication and a text communication provided by an interface of the electronic game.

3. The method of claim 1, wherein the communication is at least one of audio output and text output of a character of an electronic game.

4. The method of claim 1, wherein converting the communication includes replacing at least one of voice, audio and text of the communication with a translated communication as the replacement segment.

5. The method of claim 1, wherein the localization setting includes at least one of a regional, location and language preference of the user.

6. The method of claim 1, wherein the machine learning model is configured based on a training set of data for the user and a localization dataset.

7. The method of claim 1, wherein converting the communication includes replacing the at least one segment including offensive commentary.

8. The method of claim 1, further comprising detecting a reaction of the user to the replacement segment and updating the machine learning model based on the reaction.

9. The method of claim 8, wherein detecting a reaction includes detecting, by the device, eye tracking data for the user, and wherein the eye tracking data is detected during the output of the replacement segment.

10. The method of claim 8, further comprising updating the machine learning model for language processing using the reaction of the user to the replacement segment.

11. A device configured for dynamic chat translation, the device comprising:
an interface configured to output gaming content;
a memory storing executable instructions; and
a controller coupled to the interface and the memory, wherein the controller is configured to
receive a communication for a first user of an electronic game, the device storing a localization setting for the first user;
convert the communication using the localization setting and a machine learning model for language processing, wherein converting includes replacing at least one segment of the communication with a replacement segment; and
output an updated communication including the replacement segment to the user.

12. The device of claim 11, wherein the communication is at least one of a voice communication and a text communication provided by an interface of the electronic game.

13. The device of claim 11, wherein the communication is at least one of audio output and text output of a character of an electronic game.

14. The device of claim 11, wherein converting the communication includes replacing at least one of voice, audio and text of the communication with a translated communication as the replacement segment.

15. The device of claim 11, wherein the localization setting includes at least one of a regional, location and language preference of the user.

16. The device of claim 11, wherein the machine learning model is configured based on a training set of data for the user and a localization dataset.

17. The device of claim 11, wherein converting the communication includes replacing the at least one segment including offensive commentary.

18. The device of claim 11, further comprising detecting a reaction of the user to the replacement segment and updating the machine learning model based on the reaction.

19. The device of claim 18, wherein detecting a reaction includes detecting, by the device, eye tracking data for the user, and wherein the eye tracking data is detected during the output of the replacement segment.

20. The device of claim 18, further comprising updating the machine learning model for language processing using the reaction of the user to the replacement segment.
